(19) United States
(12) Patent Application Publication
(10) Pub. No.: US 2014/0359705 A1
(43) Pub. Date: Dec. 4, 2014

(54) Granting Permission to Use an Object Remotely with a Context Preserving Mechanism

(71) Applicant: HEWLETT-PACKARD DEVELOPMENT COMPANY, L.P., Houston, TX (US)

(72) Inventors: Alan H. Karp, Palo Alto, CA (US); Marc Douglas Stiegler, Kingman, AZ (US)

(21) Appl. No.: 13/906,707

(22) Filed: May 31, 2013

(51) Int. Cl. H04L 29/06

(52) U.S. Cl. CPC H04L 63/10
USPC 726/4

(57) ABSTRACT

Granting permission to use an object remotely with a context preserving mechanism includes selecting an object stored at a first electronic location based on user input, granting permission to a subject to use the object remotely by selecting the subject based on the user input, and visually depicting a sharing relationship with the subject in response to using the object based on the user input.

### BACKGROUND

User devices, such as laptops and tablets, allow users to use objects, such as games, documents, images, and so forth. Users can share some types of objects, like documents and images, with others by sending these objects as attachments in emails.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an example of a granting system according to the principles described herein.

FIG. 2 is a diagram of an example of a display depicting multiple tiles according to the principles described herein.

FIG. 3 is a diagram of an example of opening a tile according to the principles described herein.

FIG. 4 is a diagram of an example of displaying an object in a sharing context according to the principles described herein.

FIG. 5 is a diagram of an example of displaying an object in a sharing context according to the principles described herein.

FIG. 6 is a diagram of an example of receiving a handle according to the principles described herein.

FIG. 7 is a diagram of an example of a method of granting permission to use an object remotely with a context preserving mechanism according to the principles described herein.

FIG. 8 is a diagram of an example of a granting system according to the principles described herein.

FIG. 9 is a diagram of an example of a granting system according to the principles described herein.

### DETAILED DESCRIPTION

Sending a document in an email as an attachment results in two copies of the document. If the recipient of the email changes the document, the recipient has to send the modified document back to the user, so that the user has the changes. Further, sharing a document with another by uploading the document to a common network location that is accessible to both users, often involves setting up an account with passwords, user names, and permissions. Such a process makes sharing documents or other objects cumbersome.

The principles described herein include a method for granting permission to use an object remotely with a context preserving mechanism. Such a method includes selecting an object stored at a first electronic location based on user input, granting permission to a subject to use the object remotely by selecting the subject based on the user input, and visually depicting a sharing relationship with the subject in response to using the object based on the user input.

Such a method allows a user to share an object stored on his user device with another. Based on the permissions granted to the subject, the subject can use the object remotely from a second electronic location. For example, the subject can play a game remotely or modify a document. In the example where the subject modifies a document stored at the first electronic location, the changes will be automatically made in the document at the first location based on the subject's commands. Thus, the subject does not have to send an electronic copy of the document to the user to show the changes.

A further advantage of such a method is that the user can share the object with the subject with minimal user interaction. Such a method causes the user to make just two commands, a selection command to select the object to share and another selection command to select the subject. In some examples, each selection command is based on a single click input. For examples, selecting the subject tile may be accomplished when the user provides a click input when a cursor is positioned over the subject tile. Likewise, the object selection command may be accomplished when the user provides a click input when the cursor is located over the object tile. Thus, the user does not have to create passwords, set up an account, or create an attachment to share documents or programs.

Another advantage of the above method is that the context in which the object is shared is visually depicted. For example, while the user is using the object, the user can see with whom the object is shared, and the user can also see the user's relationship with the subject. For example, when the user opens a tile that represents the subject, each of the objects that the user is currently sharing with that subject will appear in the subject's tile. When the user controls the object, the user will control the object within the subject's tile. As a result, the user is reminded that the object is shared with that particular user. Thus, the user is also reminded of how the user has shared the object. The relationship between the user and the subject is also visually depicted. For example, if the user is a co-worker, the subject's tile can be located within a work tile. The user navigates to the subject tile through the work tile, and both the work tile and the subject tile are visually displayed as the user uses the object. Thus, the user can see both the subject and the user's relationship with the subject because the work tile and the subject are visually depicted when the user is using the shared object.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

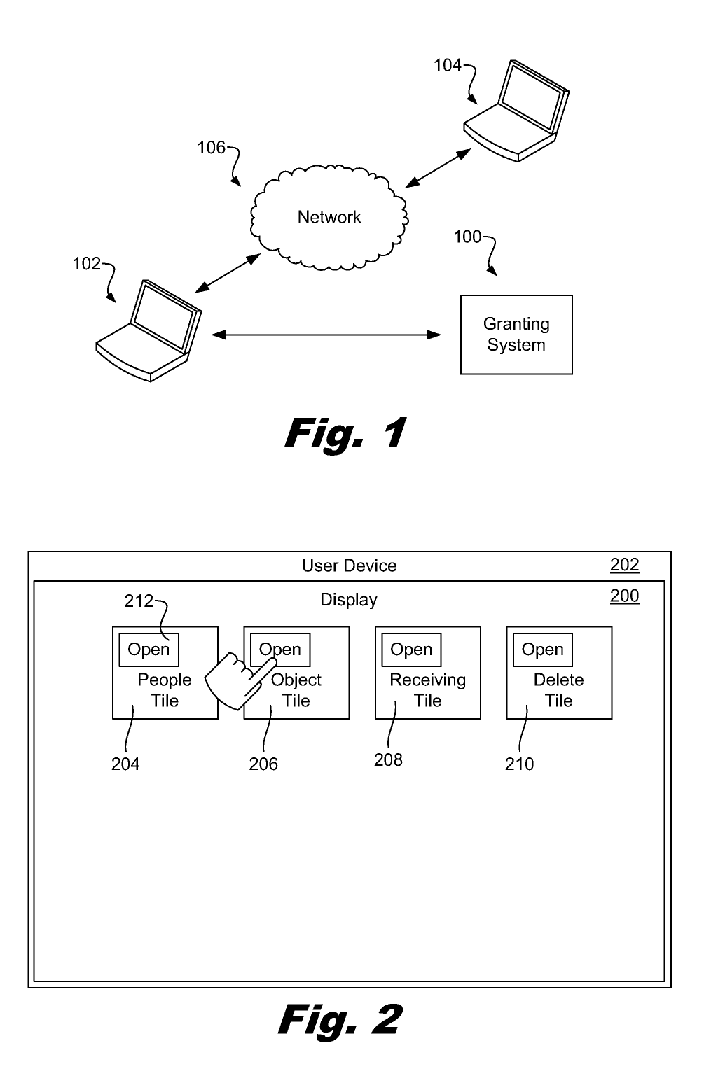

FIG. 1 is a diagram of an example of a granting system (100) according to the principles described herein. In this example, a user device (102) and a subject device (104) are in communication with the network (106). Also, in communication with the user device (102) is the granting system (100). Each of these devices (102, 104) is an electronic location where electronic objects can be used.

The granting system (100) may be incorporated into the user device (102). In other examples, the granting system (100) is also incorporated into the subject device (104). In yet other examples, the granting system (100) is in communication with the user device (102) and the subject device (104) over a network (102).

The user device (102) and/or the subject device (104) may be any appropriate device that a user can use to communicate with other components over the network (106). For example, the user device (102) and/or subject device (104) may be a laptop, a personal computer, a desktop, a phone, an electronic tablet, an electronic device, a wearable computing device, another type of user device, or combinations thereof.

The user selects an object in a display of the user device that the user desires to share with the subject. The object may be a document, a game, a program, an image, an application, another type of object, or a combination thereof. The user may select the object by selecting a designated “share” button associated with a tile that contains the desired object. In other examples, the user selects the desired object with a predetermined key stroke, a number of mouse clicks, another mechanism, or combinations thereof. Any appropriate mechanism for selecting the object may be used in accordance with the principles described herein.

The tiles may contain references, such as an icon, to the objects. To select the object, the user may select the icon that represents the object. However, any appropriate mechanism for presenting the object in the tiles may be used in accordance with the principles described herein. For example, the tiles may contain the object itself, an electronic handle to the object, an icon representing the object, another type of reference to the object, or combinations thereof.

Also, the user selects the subject with whom the user desires to share the object. The subject may have an existing relationship with the user and already have data about the subject stored on the user device (102). For example, the subject may be a co-worker, and the user may have the subject's name, image, electronic address, and other information pertaining to the subject already stored on the user device (102). Further, the user device may have a tile dedicated to each of the potential subjects. In such examples, the user can select the tile associated with the intended subject. In other examples, the user selects the intended subject with a predetermined key stroke, a number of mouse clicks, or another mechanism. Any appropriate mechanism for selecting the intended subject may be used in accordance with the principles described herein. While this example has been described with specific reference to the user first selecting the electronic object and then selecting the intended subject, the selection order may be reversed such that the user first selects the intended subject and then selects the electronic object to share.

In response to selecting the intended subject and the object, a handle is sent to the intended subject. Any appropriate mechanism for sending the handle to the subject may be used in accordance with the principles described herein. For example, the handle may appear in a receiving tile on the subject device (104). In other examples, the handle is sent as an attachment in an email to the subject. Whatever the mechanism used to send the handle to the subject, the handle maintains an electronic address of the location of where the electronic object is stored. Thus, the handle includes a hyperlink to the location of the object.

In some examples, the subject will have limited permissions to use the program that controls the object. For example, if the user shares a written document with the subject when the written document is in an editing mode, the permissions that the granting system gives the subject may include permissions to edit the selected written document. In such an example, the subject can remotely use the word processing program stored at the first electronic location or use a word processing program stored at the subject's location to edit the selected written document. However, even though the subject has the ability to use the word processing program of the first location, the subject is limited to interact with just the selected written documents at the first location and not allowed to interact with the other written documents stored at the first electronic location. In other examples, the granting system gives the subject permissions to just view the written document. Such permissions may be granted when the object is shared in a view-only mode.

In other examples, the user grants permission to the subject to use an object that is a game. In such an example, the subject can play the game from the subject's device. The user may grant permission for the subject to play the entire game, but in other examples, the user may grant the subject permission to just use a portion of the game. For example, the user may grant permission to just play certain levels of the game.

While the above examples have been described with reference to specific objects that the user can grant permission for a subject to use, any appropriate object may be used in accordance with the principles described herein. Further, while the examples above have been described with reference to specific types and amounts of permissions, any appropriate type or amount of permissions may be used in accordance with the principles described herein.

The user can view the object that the user sent to the subject in tiles that give the user context about with whom the user is sharing the object. For example, if the subject is the user's co-worker, the user may have already created a tile that represents the subject and placed that subject tile in a work tile. In response to the user opening the work tile, the subject tile will appear so that the subject tile is visually apparent to the user. As the user further navigates into the subject tile from the work tile, the display continues to visually communicate to the user that the opened subject tile is still within the work tile. Within the subject tile, the user can open the object. While the object is open, the user is continuing to see both the work tile and the subject tile, which reminds the user that the object is shared with the subject who is a co-worker. This gives the user context while the user is using the object.

In some examples, the same context is available for those objects that are shared with the user. For example, if another party decided to share a different object with the user, that object would appear in the tile that represents the sharing party. Further, when the user is using the shared object from the other party, a tile representing the other party also appears in the display to remind the user who is sharing that object with the user.

The user may receive another object from the subject or another party in any appropriate manner in accordance with the principles described herein. For example, the user may receive a handle from another party in a receiving tile on the user device (102). The user may move the handle from the receiving tile to any tile on the user device (102) as desired by the user. In some examples, the user can drop the handle by dragging an icon and/or tile representing the handle in the desired tile. The handle will have a hyperlink pointing to the electronic location where the shared object is stored. Thus, as the user uses the shared object, the shared object is controlled at that electronic location.

While this example has been described with specific reference to the user devices being the electronic locations that store the objects, any appropriate electronic location may be used in accordance with the principles described herein. For example, the electronic locations that contain the objects may be at a remote location accessible over a network.

FIG. 2 is a diagram of an example of a display (200) depicting multiple tiles according to the principles described herein. In this example, the user device (202), such as a user device or subject device, has a display (200) that depicts a people tile (204), an object tile (206), a receiving tile (208), and a delete tile (210). While this example is depicted with reference to specific tiles, any appropriate type or number of tiles may be used in accordance with the principles described herein.

Each of the tiles (204, 206, 208, 210) may be opened by selecting an open button (212). In response to opening one of the tiles (204, 206, 208, 210), other tiles contained within the opened tiles will appear. For example, in response to opening the people tile (204), multiple tiles representing specific people will appear within the people tile (204). These people can be selected as subjects for sharing the objects.

In response to opening the object tile (206), multiple tiles dedicated to specific objects will appear in the object tile (206). Such objects can be opened and used within the object tile (206). The receiving tile (208) may include tiles of objects that another party is sharing with the user. The delete tile (210) may include objects and/or tiles that are slated to be deleted.

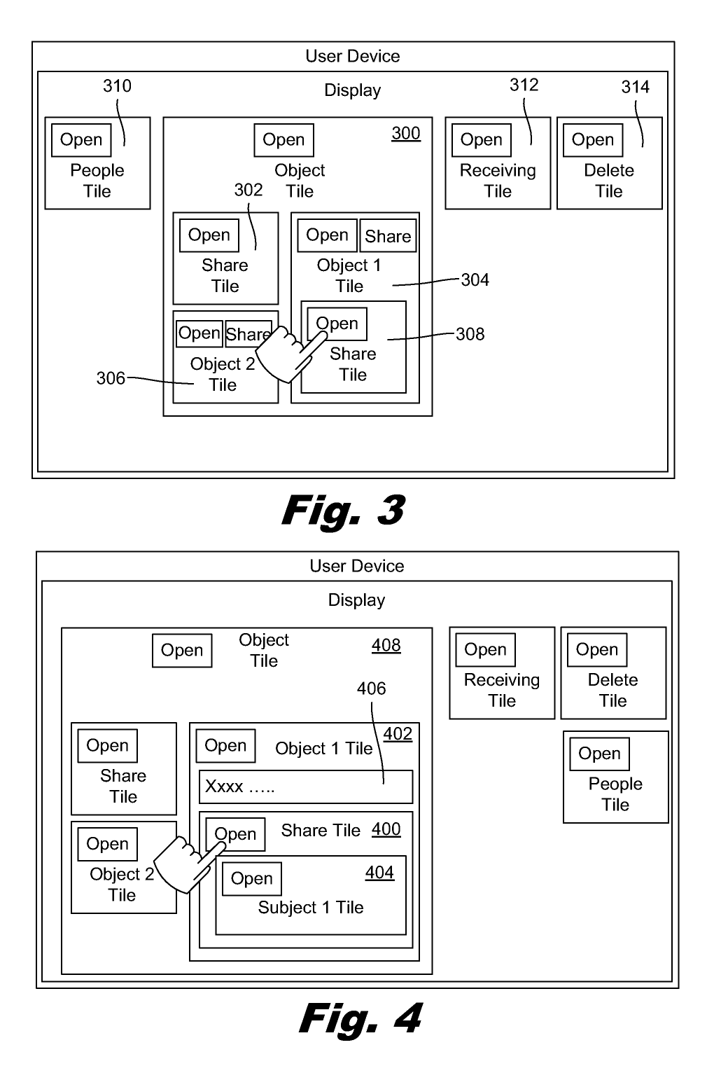

FIG. 3 is a diagram of an example of opening a tile according to the principles described herein. In this example, the opened tile is an object tile (300). Inside of the object tile (300), multiple other tiles exist. In this example, the tiles in the object tile (300) are a share tile (302), a first object tile (304), and a second object tile (306). The first object tile (304) includes an embedded share tile (308) because the first object tile (304) has already been shared with a subject.

In response to opening the object tile (300), the other tiles (310, 312, 314) outside of the object tile (300) move to accommodate an enlargement of the object tile (300). In some examples, the other tiles (310, 312, 314) may also decrease in size to accommodate the object tile's enlargement. The increased size of the object tile (300) allows each of the tiles (302, 304, 306) inside of the object tile (300) to be depicted within the object tile (300). By seeing these tiles (302, 304, 306) within the object tile (300), a user has context that these tiles (302, 304, 306) are grouped within the object tile (300). Another option within the principles described herein is for the opened tile to cover other tiles in its containing tile.

The object tile (300) may enlarge to any appropriate size in accordance with the principles described herein. For example, the object tile (300) may increase in size just enough to accommodate a visual depiction of each of the tiles within the object tile (300). In other examples, the object tile (300) may enlarge to an even larger size.

The embedded share tile (308) is created in response to the first object being shared with a subject. The embedded share tile (308) can be opened by selecting the “open” button (312) on the embedded share tile (308). In response to selecting the “open” button (312), the embedded share tile (308) is enlarged to display the subject tile or subject tiles that represent the subject with which the first object (304) is shared.

FIG. 4 is a diagram of an example of displaying an object in a sharing context according to the principles described herein. In this example, the embedded share tile (400) in a first object tile (402) has been opened. As a result, the share tile (400) is enlarged to depict the first subject tile (404), which is dedicated to a subject with whom the first object is shared. In examples where the first object was shared with multiple subjects, multiple subject tiles are depicted in the embedded share tile (400). The embedded share tile (400) is enlarged to accommodate the depiction of the first subject tile (404).

Further, in this example, the content (406) of the first object is depicted. The first object can be modified by a user while the first object tile (404) is depicted in the object tile (408). Thus, the user can see that the first object has been shared with the first subject while the first object is being worked on. The visual depiction of which subjects have received a copy of the first object can be helpful to remind the user about the context of the first object. Such a visual depiction reminds the user of who has permission to use the object. In some examples, the tile in which the user has located the first object may be a tile other than the object tile (408). For example, the tile may be a school tile, a work tile, a non-profit tile, a user specified tile, or another type of tile that reminds the user that the document is shared with a subject from school, work, a non-profit, or some other organization. Thus, the visual depiction gives the user the context about the electronic document because the user is visually reminded about which subjects with whom the object is shared, but the user is also reminded about the existing relationship that user has with the subject.

In some examples, a subject may have multiple existing relationships with a single subject. For example, a subject may be a co-worker, and therefore be included in a work tile on the user's device, and the same subject may also be a volunteer at a non-profit organization with the user. The user may have a tile dedicated to work, which includes tiles that represent the co-worker. Further, the user may have another tile for the non-profit organization, which includes tiles for those who are associated with the non-profit organization. However, just a single tile may represent the subject, but the tile may be assigned to both the work tile and the non-profit tile.

The principles described herein may give the user context about which relationship that the user has with the subject. For example, if the user navigates to the subject's tile through the non-profit tile, when the user makes changes to the object shared with the subject, the object will be viewed in the context of the non-profit tile. On the other hand, if the user navigates to the subject's tile through the work tile, the work tile will be displayed as the user uses the object. In either approach, the user will be reminded that the object is shared with the subject through an existing relationship.

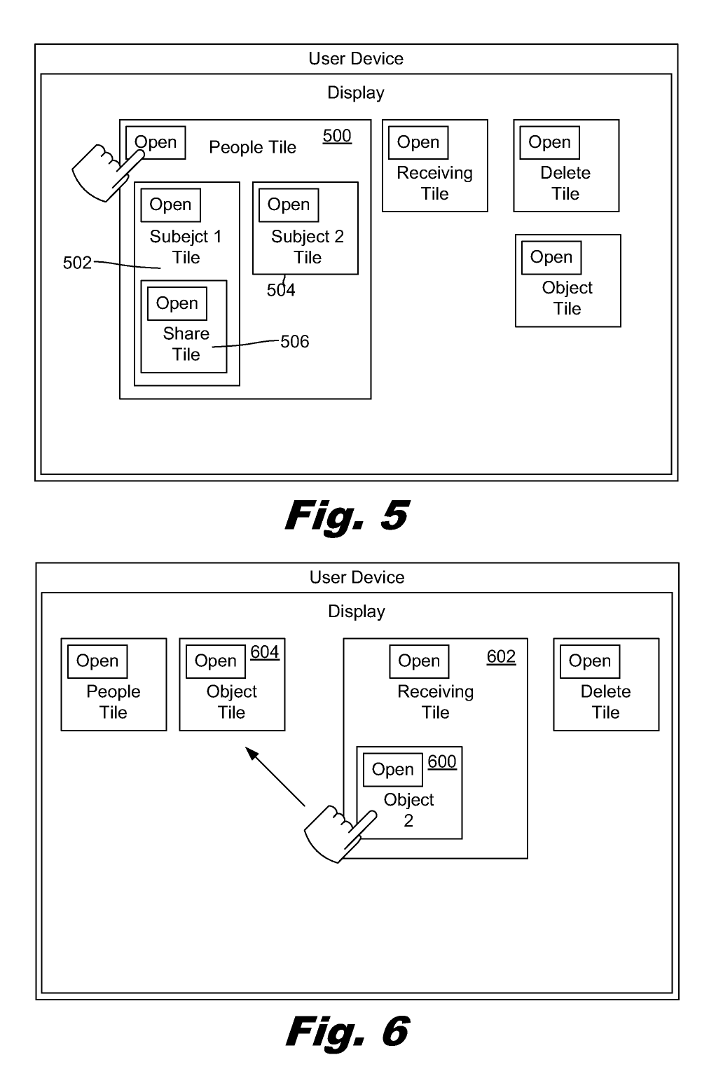

FIG. 5 is a diagram of an example of displaying an object in a sharing context according to the principles described herein. In this example, a people tile (500) is opened, which includes a first subject tile (502) and a second subject tile (504). At least one document has been shared with the first subject, thus, a share tile (506) appears in the first subject tile (502). By navigating through the people tile (500), the user can determine which objects have been shared with which subjects. Thus, if a user navigates to a shared object through a people tile, the user will have context about which other objects are shared with the subject while the user is using the object.

The display can preserve the context in which the object is shared by displaying the object in tiles that depict the subject and/or the subject's relationship with the user. For example, when the user uses an object by navigating to the object through a work tile and then the subject's tile, both the work tile and the subject tile will be open such that the user is reminded of the sharing context. The object may be displayed in any appropriate tile according to the principles described herein. For example, the shared object may be displayed in a sharee tile, a sharer tile, a subject tile, an object tile, a user designated tile, a designated sharing tile, another type of tile, or combinations thereof.

FIG. 6 is a diagram of an example of receiving a handle (600) that represents a shared object according to the principles described herein. In this example, the handle (600) is represented by an icon and is received by the user through a receiving tile (602). The user may find handles representing shared objects from various parties with the user by opening the receiving tile (602). The user may drag the handle (600) to another tile by dragging the handle (600) and dropping the handle (600) in a desired tile (604) for storage and use. In some examples, the user can drop the receiving tile in an appropriate tile that reminds the user of the sharing context with the party that is sharing the object with the user. In other examples, an “add to” button can be used to make a copy of the received object at the desired location. Further, a “move to” button can be used to make the copy and then remove the originally received object after adding the object to the desired location. Any appropriate mechanism for placing the received object or reference to the received object may be used in accordance with the principles described herein.

The handle (600) can point to the original location where the object of the handle (600) remains. Thus, as the user makes instructions through the handle (600), the object at the remote location is controlled according to the user's instructions. In some examples, the handle (600) appears to the user to be the actual object. For example, an icon representing an object that is a written document at a remote location may appear to the user to be an icon for a local document. As the user makes changes to the document, the handle may cause the user to feel as though the user is making changes to a local document. Further, the user may save the handle as though the handle were a local document. However, the user may be limited to specific activities that the user can do with the handle based on the permissions granted to the user. For example, the user may be able to read an object that is a written document, but the user may not be able to edit the object through the handle based on the permissions granted.

In additional to viewing the objects that the user has shared with subjects by navigating to tiles that represent the subjects, the user can also view the handles of the objects that the subject is sharing with the user in the subject's tile. This context allows the user and the subject to understand which objects they each have. For example, the user can determine if the subject has a particular object by viewing which objects are being shared between the subject and the user. Further, the user may visually determine if the subject has handles to all of the objects that the user desires for the subject to have.

In some examples, the user receives an electronic copy of the object with an embedded handle. In such an example, the object may appear to be the actual object to the user. If the permissions allow the user to edit the object, the electronic copy may be synchronized with the actual object stored at a different electronic location.

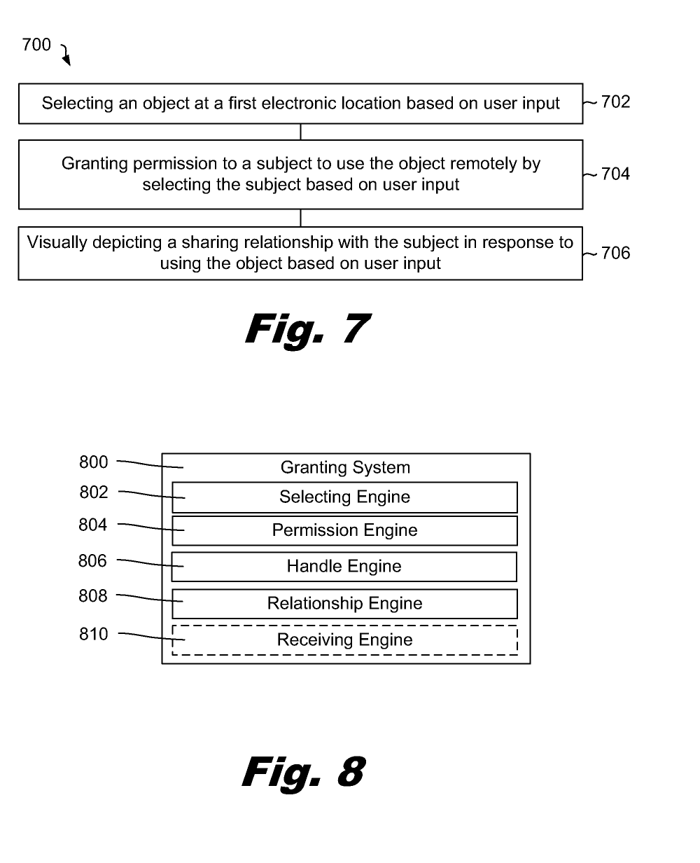

FIG. 7 is a diagram of an example of a method (700) of granting permission to use an object remotely with a context preserving mechanism according to the principles described herein. In this example, the method (700) includes selecting (702) an object stored at a first electronic location, granting (704) permission to a subject to use the object remotely by selecting the subject based on user input, and visually depicting (706) a sharing relationship with the subject in response to using the object based on user input. The electronic locations may be user devices or storage locations that are in communication with the user devices.

Selecting the object tile that represents the object may include recognizing a single click input on the object as user input. Further, selecting the subject tile that represents the subject may include recognizing a single click input on the subject tile as the user input. In such examples, the user may share the object with the subject with minimal interaction, such as just two clicks.

In some examples, the method may also include receiving a handle from a receiving tile at the first electronic location where the handle has a hyperlink to another electronic location. The handle allows the user to control an object from a different electronic location remotely based on the permissions that the user has to use the application. In other examples, the user receives an electronic copy of the object in the receiving tile. In such an example, any changes that the user makes to the object can be synchronized with the original object based on a handle sent with the electronic copy of the handle.

The object may be shared with any appropriate mechanism. For example, a handle may be sent to the user via an active stream, to a receiving tile, an email address, an instant message mechanism, a social network application, another mechanism, or combinations thereof.

The object may be displayed in a subject tile, a sharee tile, a designated sharing tile associated with the object, another appropriate tile, or combinations thereof. The sharing context, in which the shared object is displayed, may be a context that allows the user to determine with whom an object is shared, what other objects are shared with the subject, what is the existing relationship between a user and the subject, other contextual information, or combinations thereof.

Also, the user may have multiple relationships with a single subject. However, the principles described herein allow the user to visually see through which of the relationships the object is shared with the subject. For example, if the user both works with the subject and serves on a local non-profit board with the subject, the user will have a work relationship and a non-profit relationship with the subject. Accordingly, the user may have a work tile and a non-profit tile on a screen of the user's device. A dedicated subject tile will be inside each of the work tile and the non-profit tile. When the user locates the shared object by navigating to the subject tile through the work tile, the object will displayed in the both the subject tile and the work tile. Thus, the user is reminded that the user's sharing relationship with the subject is a work relationship.

Any appropriate mechanism for determining the permissions to grant to the subject may be used in accordance with the principles described herein. In one example, the granted permissions are based on the mode of the object which the object is shared. For example, if the object is shared in an edit mode, the subject will have permission to edit the object. In other examples, if the object is in a view-only mode, the subject will only have permissions to view the object. While this example has been described with reference to specific modes, any appropriate mode may be used in accordance with the principles described herein. For example, the mode may control the duration that the subject can view the object, the amount of the object that the subject can view or use, the levels of a games on the object that the subject can play, other permissions, or combinations thereof.

FIG. 8 is a diagram of an example of a granting system (800) according to the principles described herein. The granting system (800) includes a selecting engine (802), a permission engine (804), a handle engine (806), and a relationship engine (808). In this example, the granting system (800) also includes a receiving engine (810). The engines (802, 804, 806, 808, 810) refer to a combination of hardware and program instructions to perform a designated function. Each of the engines (802, 804, 806, 808, 810) may include a processor and memory. The program instructions are stored in the memory and cause the processor to execute the designated function of the engine.

The selecting engine (802) selects an object to share in response to user input. For example, a user may instruct the granting system (800) to select a game by selecting a share button associated with the game. The permission engine (804) grants permission for a subject to use the object in response to the user selecting a subject tile that represents the desired subject.

The handle engine (806) sends a handle to the subject that allows the subject to use the object remotely. The relationship engine (808) displays the context in which the object is shared. For example, if the user shared an object with a subject, when the user is using the object, a tile representing the subject will appear in the display. In some examples, the relationship engine (808) will also display the object when the subject's tile is accessed. The receiving engine (812) will receive the objects that are shared with the user. In some examples, the shared object will be received in a receiving tile.

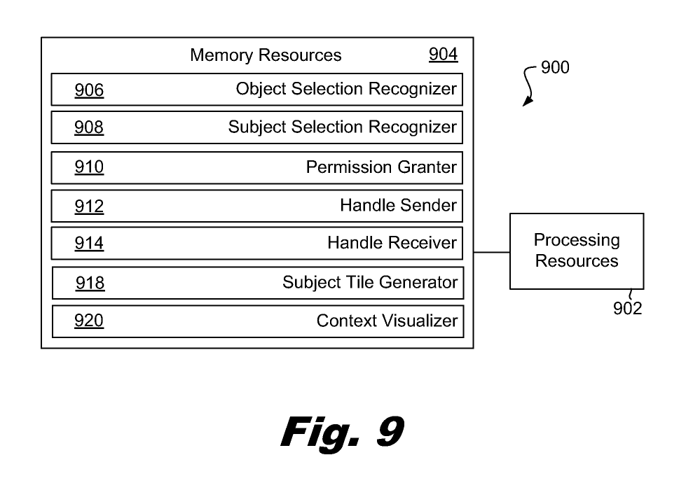

FIG. 9 is a diagram of an example of a granting system (900) according to the principles described herein. In this example, the granting system (900) includes processing resources (902) that are in communication with memory resources (904). Processing resources (902) include at least one processor and other resources used to process programmed instructions. The memory resources (904) represent generally any memory capable of storing data such as programmed instructions or data structures used by the granting system (902). The programmed instructions shown stored in the memory resources (904) include an object selection recognizer (906), a subject selection recognizer (908), a permission granter (910), a handle sender (912), a handle receiver (914), a subject tile generator (916), and a context visualizer (918).

The memory resources (904) include a computer readable storage medium that contains computer readable program code to cause tasks to be executed by the processing resources (902). The computer readable storage medium may be tangible and/or non-transitory storage medium. The computer readable storage medium may be any appropriate storage medium that is not a transmission storage medium. A non-exhaustive list of computer readable storage medium types includes non-volatile memory, volatile memory, random access memory, memristor based memory, write only memory, flash memory, electrically erasable program read only memory, magnetic storage media, other types of memory, or combinations thereof.

The object selection recognizer (906) represents programmed instructions that, when executed, cause the processing resources (902) to recognize user input that instructs the granting system (900) to select an object for sharing. The subject selection recognizer (908) represents programmed instructions that, when executed, cause the processing resources (902) to recognize user input that instructs the granting system (900) to select a subject to share the object with. The permission granter (910) represents programmed instructions that, when executed, cause the processing resources (902) to grant the permissions that control what the subject can do with the object. In some examples, the permission granter (910) determined what mode the object is in when the object is selected to be shared. In such examples, the permission granter (910) granted permissions that reflect the parameters of the object's mode. The handle sender (912) represents programmed instructions that, when executed, cause the processing resources (902) to send a handle to the subject to allow the subject to use the object. The handle may include the permissions that controls what the subject can do with the object remotely. In other examples, the object has the permissions and thus the permissions are controlled locally.

The handle receiver (914) represents programmed instructions that, when executed, cause the processing resources (902) to receive a handle from another location that gives a user of the first location the ability to use an object at a second location. The subject tile generator (916) represents programmed instructions that, when executed, cause the processing resources (902) to generate a tile that represents the subject. The subject tile generator (916) may generate the subject tile before an object is selected to be shared with the subject based on the user's relationship with the user. For example, the subject tile generator may generate multiple tiles for the subject. Each of the subject tiles may be placed in a user designated tile, such as a work tile, a non-profit tile, a school tile, a family tile, another type of tile, or combinations thereof.

The context visualizer (918) represents programmed instructions that, when executed, cause the processing resources (902) to visualize the context in which the object is shared. For example, the context visualizer (918) can cause the object to appear in the subject's tile, a designated sharing tile, a sharee tile, another type of tile, or combinations thereof. The context visualizer (918) can cause the sharing relationship to be visually apparent when the user is using the object.

Further, the memory resources (904) may be part of an installation package. In response to installing the installation package, the programmed instructions of the memory resources (904) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (902) and the memory resources (904) are located within the same physical component, such as a server, or a network component. The memory resources (904) may be part of the physical component's main memory, caches, registers, non-volatile memory, or elsewhere in the physical component's memory hierarchy. Alternatively, the memory resources (904) may be in communication with the processing resources (902) over a network. Further, the data structures, such as the libraries and may be accessed from a remote location over a network connection while the programmed instructions are located locally. Thus, the granting system (900) may be implemented on a user device, on a server, on a collection of servers, or combinations thereof.

The granting system (900) of FIG. 9 may be part of a general purpose computer. However, in alternative examples, the granting system (900) is part of an application specific integrated circuit.

While the examples above have been described with reference to sharing a single object, multiple objects may be shared at a time with the subject. For example, the user may select multiple objects with a single click input to select each object before selecting a subject. Further, a single or multiple objects may be shared with multiple subjects at once. In such an example, multiple subjects can also be selected with click inputs.

While the examples above have been described with reference to tiles with specific shapes, looks, patterns, colors, and other presentational aspects, any appropriate shape, look, pattern, color, and/or other presentational aspect may be used for the tiles in accordance with the principles described herein. Further, while the examples above have been described with reference to specific mechanisms for selecting tiles and/or buttons associated with tiles, any appropriate mechanism for selecting tiles and/or buttons may be used in accordance with the principles described herein. For example, the tiles and/or buttons may be selected through key board inputs, voice inputs, hand gesture inputs, cursor inputs, touch screen inputs, other types of user input, or combinations thereof. Further, while the examples above have been described with reference to specific buttons associated with the tiles, like an “open” button, any appropriate type of button may be used in accordance with the principles described herein. For example, the following non-exhaustive list of buttons may be used, such as copy buttons, share buttons, open buttons, delete buttons, move buttons, save buttons, cut buttons, paste buttons, other types of buttons, or combinations thereof. Further, the tiles may be opened or otherwise controlled through other mechanisms or buttons. For example, the tiles may be controlled through cursor inputs, right click inputs, left click inputs, multiple click inputs, field inputs, menu item selection inputs, other types of inputs, or combinations thereof.

While the examples above have been described with reference to selecting objects and subjects with tiles, any appropriate mechanism for selecting the objects and/or subjects may be used in accordance with the principles described herein. For example, the objects and/or subjects may be selected from a list, a menu, a tile, a graphic, another mechanism, or combinations thereof.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for granting permission to use an object remotely with a context preserving mechanism, comprising:
selecting an object stored at a first electronic location based on user input;
granting permission to a subject to use said object remotely by selecting said subject based on said user input; and
visually depicting a sharing relationship with said subject in response to using said object based on said user input.

2. The method of claim 1, wherein selecting said object stored at said first electronic location based on said user input includes recognizing a single click input on an object tile as said user input.

3. The method of claim 1, wherein selecting said subject based on said user input includes recognizing a single click input on a subject tile as said user input.

4. The method of claim 1, further comprising sending an electronic handle from said first location to said subject that allows said subject to use said object.

5. The method of claim 1, further comprising receiving an electronic handle in a receiving tile.

6. The method of claim 1, further comprising receiving an electronic copy of a second object in a receiving tile, said electronic copy having an electronic handle to a second electronic location such that the electronic copy is synchronized with said second object at said second electronic location.

7. The method of claim 1, wherein visually depicting said sharing relationship with said subject in response to using said object based on said user input includes displaying said subject in a designated sharing tile associated with said object.

8. The method of claim 1, wherein visually depicting said sharing relationship with said subject in response to using said object based on said user input includes displaying said object in said subject tile.

9. The method of claim 1, wherein visually depicting said sharing relationship with said subject in response to using said object based on said user input includes displaying said object in said sharee tile that represents a sharee of said object.

10. The method of claim 1, wherein said subject has multiple subject tiles, each of said multiple subject tiles representing a single relationship between a sharer and said subject.

11. The method of claim 1, wherein said permissions gives said subject partial permissions to use said object based on a mode of said object when said object is selected for sharing.

12. A system for granting permission to use an object remotely with a context preserving mechanism, comprising:
a selecting engine to select an object tile that represents an object stored at a first electronic location;
a granting engine to grant permission to a subject to use said object remotely by selecting a subject tile representing said subject based on said user input;
a handle engine to give said subject an ability to use said object; and
a relationship engine to visually depict a sharing relationship with said subject in response to using said object based on said user input.

13. The system of claim 12, wherein the granting engine is to further grant permission based on a mode of said object when said object is selected for sharing.

14. A computer program product for granting permission to use an object remotely with a context preserving mechanism, comprising:
a non-transitory computer readable storage medium, said non-transitory computer readable storage medium comprising computer readable program code embodied therewith, said computer readable program code comprising program instructions that, when executed, cause a processor to:
select an object stored at a first electronic location;
grant a subset of permissions to a subject to use said object remotely by selecting a subject tile representing said subject based on said user input, said subset being determined by a present mode of said object;
give said subject an ability to use said object;
display said object in said subject tile; and
display said subject tile in response to user input to use said object.

15. The computer program product of claim 14, wherein said program instructions, when executed, cause said processor to grant permissions based on a mode of said object when said object is shared.
